(19) United States
(12) Patent Application Publication
(10) Pub. No.: US 2015/0119123 A1
(43) Pub. Date: Apr. 30, 2015

(54) SYSTEM AND METHOD FOR CONDUCTING ON-LINE POKER TOURNAMENTS

(71) Applicant: KIZZANG LLC, Las Vegas, NV (US)

(72) Inventor: Robert Alexander, Las Vegas, NV (US)

(21) Appl. No.: 14/288,373

(22) Filed: May 27, 2014

Related U.S. Application Data
(60) Provisional application No. 61/895,782, filed on Oct. 25, 2013.

(51) Int. Cl. G07F 17/32

(52) U.S. Cl. CPC G07F 17/3293
USPC 463/13

(57) ABSTRACT

An on-line poker tournament that will conclude within a time period specified by the tournament organizer, or nearly so, regardless of the number of participants. Registered players are forced “all in” for one or more hands of poker until only a predetermined number of players (or fewer) remain. Thereafter, the remaining players are permitted to play against one another in conventional play, until a predetermined time before a designated end time of the tournament. At that time, players are forced all in for each hand until an overall tournament winner is determined. In this way, the tournament completes at the specified end time (or nearly so).

### RELATED APPLICATIONS

This application is a NONPROVISIONAL of, claims priority to and incorporates by reference U.S. Provisional Application 61/895,782, filed Oct. 25, 2013.

### FIELD OF THE INVENTION

The present invention relates to on-line gaming, and more specifically to methods and systems for conducting on-line poker tournaments open to large number of participants.

### BACKGROUND

On-line gaming has become immensely popular and all manner of games are available to individuals who wish to play. Among the most popular forms of on-line games are those that involve casino-style games, such as blackjack, poker, slots, craps, etc. While these games can often be played in a solo fashion, e.g., where a single player plays against the “house”, many players prefer the excitement of tournament play where multiple players compete against one another (and sometimes also against the house).

Despite its popularity, tournament play for on-line games is often difficult for the players involved. This is often because the tournament is conducted around a date and time set by the tournament organizer (e.g., the on-line game provider), and all players must be ready to play, and play, at the designated date(s) and time(s). The players must also be prepared to play for extended periods of time during the scheduled tournament time. This means that would-be players who cannot alter their work or other schedules to accommodate the tournament organizer's plans are precluded from participating in the tournament. Such a situation is unsatisfactory for both the tournament organizer and the would-be players as both miss out on opportunities that would otherwise be present if the players could participate in the tournament.

### SUMMARY OF THE INVENTION

An on-line poker tournament that will conclude within a time period specified by a tournament organizer is implemented in a client-server arrangement and characterized by rules of play that force registered players “all in” for one or more hands of poker until only a predetermined number of players (or fewer) remain in the tournament; thereafter, until a predetermined time before a designated end time of the tournament, permit remaining players to play against one another using without requiring all in wagers; and, at and after the predetermined time before a designated end time of the tournament, force all then-current players all in for each hand of poker until an overall tournament winner is determined.

### BRIEF DESCRIPTION OF THE DRAWINGS

The present invention is illustrated by way of example in the figures of the accompanying drawings, in which:

FIG. 1 illustrates a client-server arrangement through which players can participate in on-line tournaments conducted in accordance with embodiments of the present invention;

FIG. 2 illustrates an example of a process for conducting on-line tournaments according to an embodiment of the present invention;

FIG. 3 illustrates an example of a process for conducting on-line poker tournaments according to an embodiment of the present invention; and

FIG. 4 illustrates an example of a computer system configurable in accordance with embodiments of the present invention.

### DESCRIPTION

The present invention addresses problems with existing on-line game tournaments, and in particular poker tournaments, by allowing players to play in on-line tournaments that are scheduled to last for no more than an organizer-specified tournament duration. In one embodiment, an on-line tournament, e.g., a poker tournament, is organized and players are permitted to play for specified a length of time. For example, a tournament may be scheduled to start at 10:00 AM Eastern Standard Time, January 1 and end at 11:00 AM Eastern Standard Time on the same day. This way, individual players may schedule their participation in the tournament and be assured that all play will be completed no later than the specified end time. Of course, in some instances the play may extend, for a few minutes or so, past the specified end time in order to allow the tournament to come to a conclusion by having one participant win.

In some embodiments of the invention, a tournament may commence at a date/time within designated tournament start and end dates/times. Players may each compete for a fixed period of time, t_{play}, within the tournament date/time boundaries, tₛₜₐᵣₜ and t_{end}. Such an embodiment is particularly well suited where games are played not against other individual players, but instead against a machine (e.g., video poker, slots, etc.) and a winner can be determined though a high score or similar mechanism. In such an embodiment, players are generally required to complete their game play within a single session, that is, without any breaks or pauses once the player commences game play, but this is optional. In some embodiments, breaks or pauses may be permitted under the tournament rules. The tournament winner is generally that player who attains a highest score during the tournament (or lowest score in games where lower scores are deemed to be better than higher scores), and here a score may be determined in any of a variety of ways, for example, in terms of points, dollars, or other tokens indicative of successful game play and/or performance. In some instances, players may be permitted to play multiple times during a tournament (each playing session lasting for a period t_{play}), while in other cases players may be permitted only a single playing session per tournament. Some tournaments may have only a single winner, while other tournaments may award prizes for multiple placings by players (e.g., first place, second place, third place, etc.).

Rules of each tournament may vary depending on the game being played. For example, in some tournaments involving wagering, each separate wagering event (e.g., a turn) may involve a bet of fixed amount. For example, in a slots tournament, each “spin” of a slot machine may involve or require a fixed wager determined by the tournament organizer In other tournaments, players may be permitted to manager their wagers and place bets of their own choosing or of their own choosing between maximum and minimum limits per turn.

Rather than on-line tournaments that require enrollment (in which case a player has to be available to enroll in the tournament within the tournament enrollment parameters defined by the tournament organizer), the present tournaments are available to any member of a service offered by the tournament service provider. That is, a tournament service provider may offer membership in an organization that allows its members to participate in tournaments on an as-desired basis, without need for enrollment or registration in each individual tournament. The membership in the tournament service may be free of charge or may require payment (e.g., in the form of a monthly, annual or other subscription). In other cases, membership may be free of cash charges but members may have to agree to accept advertisements, provide person information for use by advertisers, or other conditions.

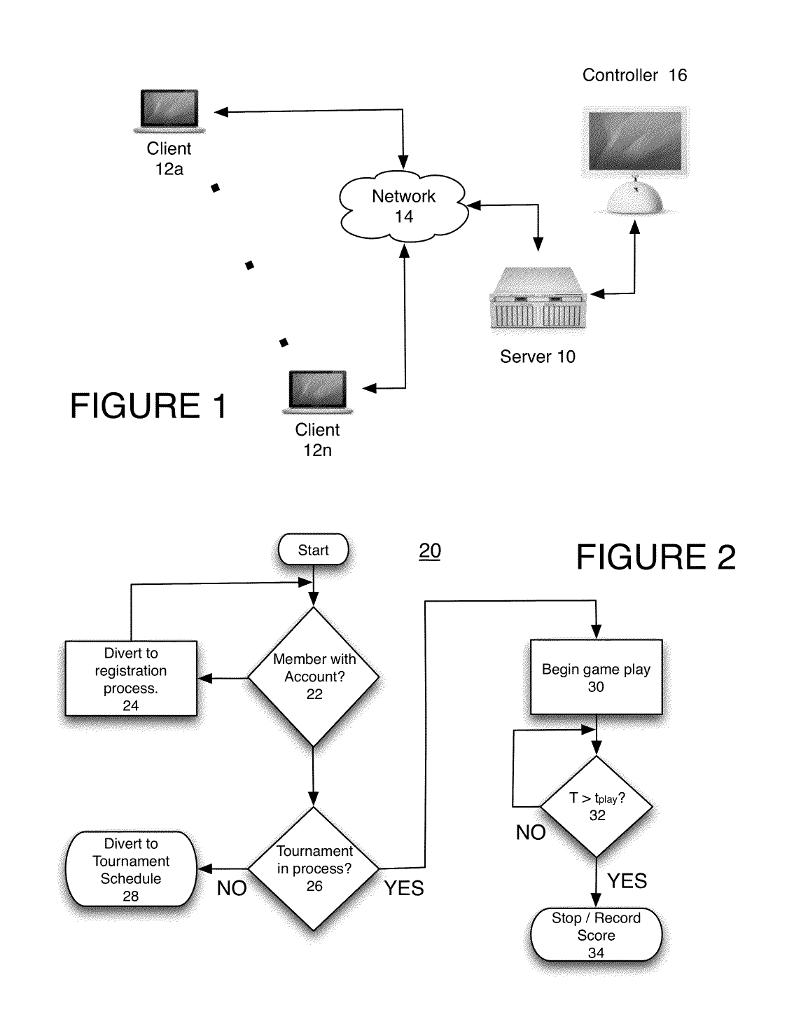

One embodiment of the present invention involves an on-line video poker tournament. In such an instance, and referring to FIG. 1, a server 10 is configured to communicate with one or more client computers 12a-12n via network 14 (e.g., the Internet) to provide players associated with the client computers access to a video poker tournament hosted on server 10. Of course, to facilitate access by hundreds or even thousands of client computers, server 10 may be a server farm with appropriate load balancers so as to provide each player with a satisfactory gaming experience that involves minimal latency. Instances of server 10 are configured by a tournament organizer, for example via controller 16, to provide the same video poker game to all players who participate in the tournament. Notification of the tournament, the tournament rules, playing conditions (e.g., wager limits/requirements), etc., may be provided to individual players upon such players logging in to a respective account, through which the players may access the tournament if and when they choose to do so. For a player engaged in the tournament, his or her playing time will commence at a date and time of his or her own choosing within the defined tournament play period. During the player's playing time, the player plays the video poker game according to the tournament rules. For each player, play ends when a time defining the playing time ends. Such times may be kept by one or more timers associated with or accessible to server 10 and each player is preferably provided with a countdown timer or other visual indicator of time remaining in the game session while the player is playing. In some instances, a dispute resolution mechanism involving a complaint procedure, an investigation procedure and, optionally, an appeal procedure, may be provided by the tournament organizer in order to accommodate players that believe technical errors resulted in problems with their tournament scores or playing times.

FIG. 2 shows an example of a process 20 executed by server 10 when a player at a client 12 connects to the server. At 22, the server may execute a process to determine whether the player is a member that has an account with the tournament service. This may be done by running a log-in or similar script that requires the user to enter log-in credentials for the service. If the player is not a member of the tournament service, the player may be diverted to a registration process 24, which provides the player with an opportunity to become a member. This may involve the player providing certain personal information, including, for example, information sufficient to establish that the player is of legal age to play in tournaments of the kind offered through the service. Although shown as an in-line process, obtaining membership in the service may be a separate process that requires some time to complete, as for example where verification of the member's age, etc. is required through secondary sources.

If the server determines that the player is a member of the service 22, the server determines whether there is an existing tournament in progress 26. This is essentially a check of whether the time for a tournament selected by the player is within the period tₛₜₐᵣₜ and t_{end}. If not, the player may be diverted to a schedule 28 that provides information regarding upcoming tournament dates/times. If, however, the player's desired tournament has commenced, the player is provided an opportunity to begin game play 30.

The server then permits the player to play the game for a period of time t_{play} 32. Upon completion, game play is concluded and the payer's score recorded 34. Upon completion of the tournament, the server determines the winner (e.g., the player with the highest score) and the winning player is so notified (not shown). Optionally, player results may be posted in a player's account or other venue where the player can review his/her own scores and, optionally, scores of other players.

Preferably, the server 10 logs information concerning a number of aspects of the tournament, For example, logs that indicate which players participated in a tournament, when, how often and for how long at a time are kept. So too are logs of all player scores, wagers, etc. Logs that record technical faults, communication problems, etc. that may become the subject of a complaint or may be grounds for providing repeat play opportunities are also kept.

FIG. 2 shows game play as being continuous during the time tₛₜₐᵣₜ<T<t_{play}, but this need not necessarily be the case. In some instances, players may be permitted to pause their play and to return at a later time within the date/time boundaries of the tournament. In such instances, the server would save the game state for the player so that the game can be again instantiated from the point at which it was paused upon the player's return.

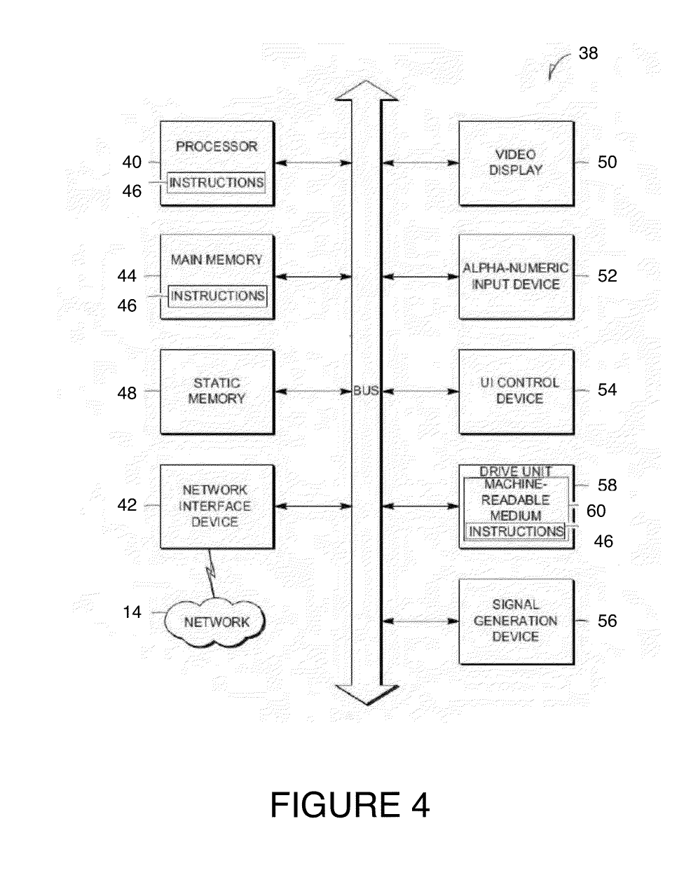

As evident from the foregoing discussion, one or more of the methods or processes described herein may be executable on various computer-based devices (e.g., clients 12 and/or server 10). Such devices, an example (38) of which is illustrated in FIG. 4, may include any electronic device capable of performing the actions described above (using suitable programming) and, where applicable, processing the information for display so as to properly convey the information. Examples of such devices include desktop computers, laptop computers, cellphones, smart phones, tablet computers, computer game consoles, portable computer gaming consoles, media players, portable media players, other mobile devices, and the like.

In such devices, a processor 40 may control the overall functions of the electronic device such as running applications and controlling peripherals. Such a processor may be any type of processor and may communicate with network interface device 42 to transmit and receive signals (e.g., cellular, Bluetooth, Wi-Fi, WiLAN, or other communication signals) over a network 14. The processor may use main memory 44 and/or a cache to store operating instructions 46 and to help in the execution of the operating instructions (e.g., such as the temporary storage of calculations and the like). The processor may also use non-transitory storage 48 and/or long-term storage 58 (such as a flash drive, hard disk or other unit comprising a tangible machine readable medium 60) to store and read instructions, files, and other data that requires long term, non-volatile storage.

The processor may communicate and control other peripherals, such as a display 50 with associated touch screen sensor, causing images to be displayed on the display and receiving input from the touch screen sensor when a user presses on the touch-screen display. In some examples, a touch screen sensor may be a multi-touch sensor capable of distinguishing and processing gestures.

The processor may receive input from a physical keyboard 52 and/or mouse/touch pad 54. In other examples, the device may utilize a touch screen keyboard using the display and touch screen sensor. The processor may produce audio output and other alerts that are played on a speaker or other signal generation device 56. A microphone (not shown) may be used as an input device for the processor to receive commands using voice-processing software. In the case of a client 12, an accelerometer may provide input on the motion of the device to the processor. An accelerometer may be used in motion sensitive applications, or, for example, in connection with scrolling content using tilting gestures, etc.

A Bluetooth module may be used to communicate with Bluetooth-enabled external devices. A USB port may enable external connections to other devices (e.g., mice or other cursor control devices) supporting the USB standard and charging capabilities. An external storage module may include any form of removable physical storage media such as a flash drive, micro SD card, SD card, Memory Stick, and the like.

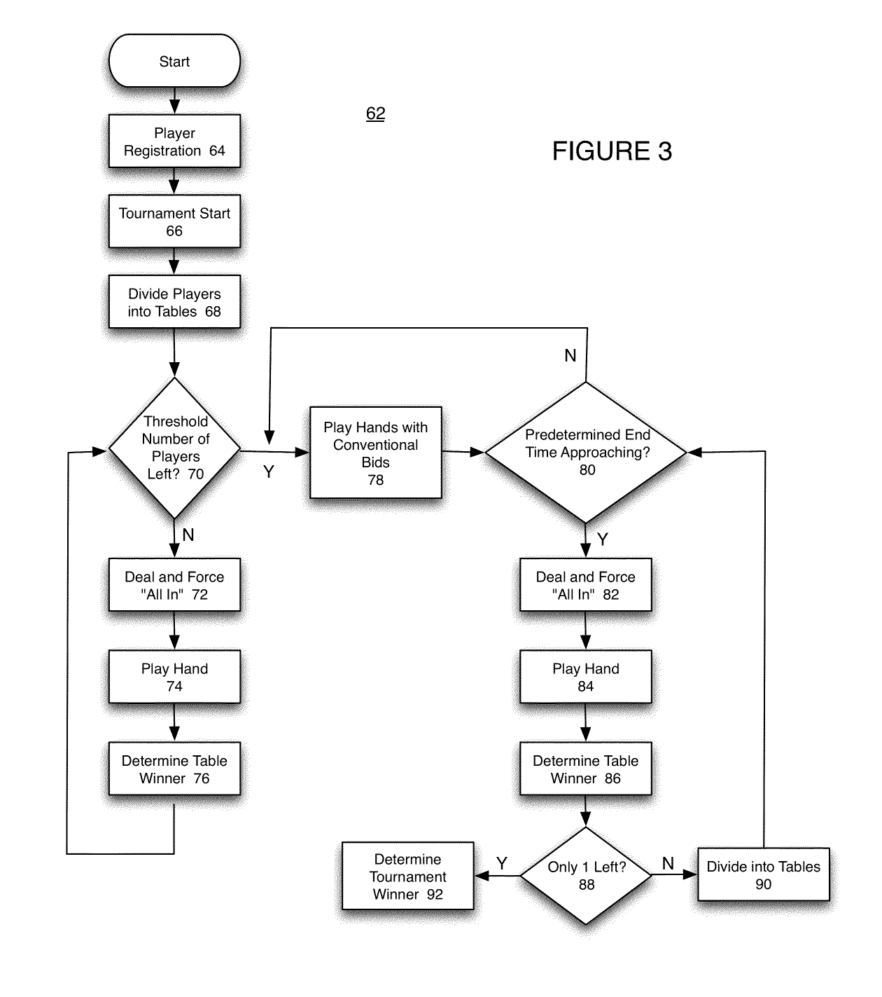

FIG. 3 illustrates a further embodiment of the present invention; specifically a process 62 for conducting an on-line poker tournament that will conclude within a time period specified by the tournament organizer, or nearly so, regardless of the number of participants. Process 62 is described with reference to an on-line poker tournament, but may be applicable to other on-line tournaments where players compete against one another and can be eliminated from the competition when they are out of tokens. In the context of a poker tournament, this means that the player has no more tokens (money or other tokens) to wager.

Process 62 begins with players registering to compete in a tournament 64. The registration process may remain open for any period of time that the tournament organizer wishes. In some cases, the period of time that the tournament registration process remains open depends upon the number of participants that register. That is, when a threshold number of participants have registered for a given tournament, registration for that tournament may be closed. In other instances, registration for a tournament may remain open until a specified date and time. For example, for a tournament that is scheduled to begin at 10:00 PM Eastern Standard Time on January 1, registration may remain open until a specified time prior to 10:00 PM Eastern Standard Time on January 1.

At the designated start time the tournament begins 66. In this example, the tournament may be a poker tournament in which participants play against each other. One such tournament may be a Texas Hold 'Em poker tournament, but other poker tournaments may be conducted in accordance with the present methods. In a conventional poker tournament, prior to cards being dealt one, two or more players would be required to wager specified amounts known as blinds. Then, after cards are dealt, players would be permitted to place wagers or fold. This pattern would continue until a specified number of cards are dealt and, if more than one player remains with an active wager, the remaining players would engage in a show down to determine a winner of the hand. This process would continue until a single winner emerged. Such a tournament could take a significant period of time to complete, especially if dozens of players were involved.

As indicated above, many players cannot participate in on-line tournaments that do not have defined playing times. The indeterminate nature of an end time for a conventional on-line poker tournament thus limits participation in such tournaments. To overcome this limitation, the present invention modifies the conventional poker game by dividing players up into “tables,” placing all players at a table “all in,” and declaring a table winner at the end of a hand. Then, winners from each table are arranged into new tables and the process is repeated. This continues until only a predetermined number of the original players remain and these players compete against one another as in a conventional game. This continues until a predetermined time prior to the specified end of the tournament, at which point if no winner has yet emerged the game reverts to putting all players “all in” for every hand until a single winner is determined. In this way, the tournament completes at the specified end time (or nearly so).

FIG. 3 illustrates further details of this process. Once the tournament has commenced, players are divided into tables 68. Tables may consist of equal numbers of players, or may consist of unequal numbers of players. Generally, tables of 8-12 players may be used, but in other instances more or fewer numbers of players per table may be used. Most tournaments will be played using only single decks of cards per table, but some tournaments may make use of multiple decks of cards per table. In such instances, tables may include many more players than could participate in a single deck game.

With the players divided into tables, a determination is made as to whether the total number of players is less than or equal to a defined threshold number of players 70. The threshold number of players may be determined by the tournament organizer and may vary depending on the type of poker game being played. In one embodiment, the threshold number of players may be 77. In other embodiments a greater or lesser number of players may be set as a threshold. In some instances, thresholds may be determined empirically over time by measuring the length of time it takes for an on-line poker tournament to be conducted. For example, if on average an initial number of players are determined to complete play within a defined time period, this information may be used to dynamically establish a threshold for a given tournament based on the number of registered participants for that tournament.

However established, if the current number of players in the tournament is greater than the threshold number of players, then the tournament is played with cards being dealt and, for that deal, putting all players “all in.” That is, all players at a table are forced to wager al of their current tokens in the current hand. The hand is then played 74, and a winner of the hand is determined 76. This procedure takes place for all of the tables and the various table winners are then again divided up into new tables of players 68. The total number of winners of the first hand is checked to determine whether or not it is less than or equal to the predetermined threshold and, if not, the above-described process repeats. This procedure of grouping successive winners of hands into new tables, putting these players all in for a hand of play and determining winners continues until the number of players remaining in the tournament is less than or equal to the threshold number of players 70.

Once the threshold number of players has been reached, the players are divided into tables and allowed to play under conventional rules (e.g., being permitted to make wagers of their own choosing or even being permitted to fold hands) 78. During this time, some players may lose all of their tokens and be eliminated from the tournament. Others may amass large number of tokens from winning hands.

As each hand at each table finishes, a determination is made as to whether the time remaining until the specified tournament end time is within a predetermined threshold time 80. For example, as each hand finishes, a check may be made to determine if less than five minutes remains until the specified tournament end time. If so, the tournament may enter its end phase. Alternatively, the running time of the tournament may be checked and upon reaching a predetermined time remaining until the specified tournament end time, regardless of whether or not individual hands at various tables are complete, the tournament may enter the end phase.

In the end phase of the tournament, a hand is dealt at each table and all players at each table are again put “all in” 82. The hand is played 84, and a winner of the hand is determined 86. This process continues until only one table of players remains 88, which each successive group of winners being placed into tables 90. Ultimately, only one table of players will remain and the winner of that hand of play will be the tournament winner 92.

The time it takes to determine a tournament winner in the end phase of the tournament, on average, may be used as the threshold time remaining until the specified tournament end time for commencing the end phase of the tournament. Alternatively, the tournament organizer may specify a threshold time. The tournament ends when a final winner is determined and so by setting the threshold time remaining until the specified tournament end time for commencing the end phase of the tournament to be a time for the tournament to complete, the tournament can be guaranteed to finish within the specified time period, or nearly so. For example, the tournament may end somewhat earlier or later than the specified end time, depending on the number of players remaining in the tournament when the end phase commences and how long it takes for all of those players to compete in the end phase.

Certain embodiments are described herein as including logic or a number of components, modules, or mechanisms. Modules or components may constitute software modules (e.g., code embodied on a non-transitory machine-readable medium) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connects the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software-as-a-service” (SaaS) service. For example, at least some of the operations may be performed by a group of computers (as examples of machines including processors), with these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. For example, the code can be stored on one or more non-transitory, or non-volatile tangible computer-readable media, and may be loaded into volatile media during execution or at other times (e.g., during a transfer between storage devices, etc.). Examples of these tangible computer-readable media can include, but are not limited to, hard disks, removable magnetic disks, removable optical disks (e.g., compact disks and digital video disks), magnetic cassettes, memory cards or sticks, read only memories (ROMs), flash memories or other solid state devices (SSDs) and the like.

What is claimed is:

1. A non-transitory computer-readable medium having stored thereon computer-readable instructions, which instructions when executed by a processor, cause said processor to conduct an on-line poker tournament that will conclude within a time period specified by a tournament organizer, the on-line tournament including steps comprising:
registering a plurality of players for the on-line poker tournament during a first period of time that registration for the on-line poker tournament is permitted, wherein the on-line poker tournament is characterized by a predetermined starting time and a predetermined end time;
at the predetermined start time commencing the tournament by permitting registered players to play against one another, playing of the tournament being characterized by:
segregating registered players for the tournament into a plurality of tables, each table comprising a number of registered players,
for each respective table of registered players, if a total number of registered players in the tournament exceeds a threshold number of players, placing all registered players at each respective table all in for a current hand of poker, playing the hand of poker, and upon conclusion of play of the hand of poker declaring a table winner;
grouping winners of the hand of poker from each respective table of registered players into succeeding respective tables of players and repeatedly, for each respective table of players, if a total number of remaining players in the tournament exceeds a threshold number of players, placing all remaining players at each respective table all in for a successive hand of poker, playing the successive hand of poker, and upon conclusion of play of the successive hand of poker declaring a table winner;
when the total number of remaining players in the tournament is less than or equal to the threshold number of players, segregating then-remaining players in the tournament into tables of players and, until a predetermined time prior to the end time of the tournament, allowing the then-remaining players in the tournament to compete against one another in successive hands of poker in which each then-remaining player is permitted to wager amounts of his or her choice;
upon reaching the predetermined time prior to the end time of the tournament, if no tournament winner has yet been determined,
for each then-current table of players, placing all players at each respective then-current table of players all in for a next hand of poker, playing the next hand of poker, and upon conclusion of play of the next hand of poker declaring a table winner;
grouping winners of the next hands of poker from each respective then-current table of players into further succeeding respective tables of players and repeatedly, for each further respective table of players, placing all remaining players at each further respective table all in for a further successive hand of poker, playing the further successive hand of poker, upon conclusion of play of the further successive hand of poker declaring a table winner, and repeating the grouping, placing and playing until an overall tournament winner is determined.

2. A non-transitory computer-readable medium having stored thereon computer-readable instructions, which instructions when executed by a processor, cause said processor to conduct an on-line poker tournament that will conclude within a time period specified by a tournament organizer, the on-line tournament characterized by rules of play that force registered players “all in” for one or more hands of poker until only a predetermined number of players (or fewer) remain in the tournament; thereafter, until a predetermined time before a designated end time of the tournament, permit remaining players to play against one another using without requiring all in wagers; and, at and after the predetermined time before a designated end time of the tournament, force all then-current players all in for each hand of poker until an overall tournament winner is determined.
